(19) United States
(12) Patent Application Publication
(10) Pub. No.: US 2007/0220581 A1
(43) Pub. Date: Sep. 20, 2007

(54) NETWORK TYPE TELEVISION VIDEO RECORDER

(76) Inventor: Ching-Shan Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,805

(22) Filed: May 9, 2006

(30) Foreign Application Priority Data
Feb. 24, 2006 (TW) 95106246

(51) Int. Cl. H04N 7/16; H04N 7/173

(52) U.S. Cl. 725/134; 725/142; 725/89

(57) ABSTRACT

A network type television video recorder (VR) comprising a user interface (Ul) unit, an image interface unit, a network interface unit, a peripheral interface unit, a system processor, an image processor, a random access memory (RAM), and a read-only memory (ROM) is provided. Using functions of the aforementioned devices, the VR receives a local instruction from the Ul unit or receives a remote instruction from the network interface unit. In response to the local instruction or the remote instruction, the VR executes a recording setting function, a recording function, a management function for managing image data in a storage device, an image playback function, compression of image data, decompression of image data, and a conversion of image data formats. The VR reads image data from an input device or a storage device and output image data to the storage device or an output device through the interface units.

### CROSS-REFERENCE TO RELATED APPLICATION

This application claims the priority benefit of Taiwan application serial no. 95106246, filed on Feb. 24, 2006. All disclosure of the Taiwan application is incorporated herein by reference.

### BACKGROUND OF THE INVENTION

1. Field of the Invention

The present invention relates to a digital image processing apparatus, and more particularly, to a network television video recorder capable of remote operation through a network.

2. Description of Related Art

The world has entered into the digital multi-media era. With the popularization of consumer electronic products such as digital cameras and digital video recorders, most consumers have the capability of recording static or dynamic image in digital format. At present, the rapid development of new techniques in the area of image sources, storage medium and playback devices have complicated the digital multi-media environment. For example, some common image sources include cameras, television program channels and networks, some common storage medium include hard discs, optical discs and memory cards, some common image playback devices include various types of televisions and displays. However, up to the present moment, a consumer product that can support a full range of the foregoing device selections in addition to permitting a remote operation through a network is still not available.

For example, most optical disc recorder can only capture images from a television program channel and store it in an optical disc and then uses a television or display device to play back. If a few more consumer products are purchased just to increase the number of items that can be supported, they may not be smoothly integrated together even if the same brand name consumer products are purchased. Furthermore, most optical disc recorder can only perform various operations according to the operating interface of the optical disc recorder. In general, a remote operation through a network is not provided.

Although the addition of suitable software and peripheral devices to a personal computer can provide support to the aforementioned list of devices, the cost of the personal computer is often prohibitively high. Moreover, installing and maintaining these software and peripheral devices are not easy tasks and are often outside the budget and beyond the knowledge capability of most consumers. In addition, the personal computer is heavy, bulky and very inconvenient to dispose and carry.

All in all, an easy to carry and low cost consumer electronic product capable of supporting all the aforementioned devices simultaneously is not yet available.

### SUMMARY OF THE INVENTION

Accordingly, at least one objective of the present invention is to provide a network type television video recorder (VR) capable of recording images from different sources, storing in different medium and playing back through different types of devices. Furthermore, the VR is inexpensive, light and compact. Besides installing inside a television for providing multiple functions, the VR can be fabricated as an independent electronic device for portability. Moreover, the VR permits a remote operation through a network.

To achieve these and other advantages and in accordance with the purpose of the invention, as embodied and broadly described herein, the invention provides a network type television video recorder. The network type television video recorder comprises a user interface unit, an interface unit, a system processor, an image processor, a random access memory and a read-only memory. The user interface unit receives a local instruction from a user. The interface unit receives a remote instruction through a network. According to the local instruction or the remote instruction, the system processor executes a recording setting function, a recording function, a management function for managing image data in a storage device or an image playback function.

According to the aforementioned local instruction or remote instruction, the image processor compresses image data, decompresses image data or converts image data format. The random access memory temporarily stores the data required by the system processor to execute the foregoing local instruction or remote instruction. The read-only memory stores the program codes necessary for executing the foregoing local instruction or remote instruction. Finally, the interface unit reads image data from an input device or a storage device and outputs the image data to the storage device or an output device.

In one embodiment of the foregoing television network video recorder, the aforementioned interface unit includes an image interface unit, a peripheral interface unit and a network interface unit. The image interface unit, the peripheral interface unit and the network interface unit are coupled to the system processor and the image processor and are capable of reading image data from the input device or the storage device and outputting image data to the storage device or the output device. Furthermore, the foregoing network interface unit may receive a remote instruction through a network and transmit remote instruction to the system processor.

In one embodiment of the foregoing network television video recorder, the image data is a dynamic image data or a static image data.

In one embodiment of the foregoing network television video recorder, the recording setting function includes at least setting the recording speed, setting the quality of the recorded picture or setting the recording time.

In one embodiment of the foregoing network television video recorder, the recording function includes reading image data from an input device and storing the image data inside a storage device.

In one embodiment of the foregoing network television video recorder, the playback function includes reading image data from an input device or a storage device and outputting the image data to an output device.

In one embodiment of the foregoing network television video recorder, the playback function includes playing back the image fast forward, in slow speed, frame-by-frame or in a stationary frame manner. The image playback function also includes selecting images for playback according to recording time, movie title or section title. Furthermore, this also includes playing the image forward or backward.

In one embodiment of the foregoing network television video recorder, the image interface unit has at least one group of image interface connectors so that the image interface unit is able to transmit image data through one of the image interface connectors. The peripheral interface unit also has at least one group of peripheral interface connectors so that the peripheral interface unit is able to transmit image data through one of the peripheral interface connectors. Similarly, the network interface unit also has at least one group of network interface connectors so that the network interface unit is able to transmit image data through one of the network interface connectors.

In one embodiment of the foregoing network television video recorder, the input device is a camera, a television cable, an optical disc recorder, a hard drive, a card reader, an optical disk drive, a cable network, a wireless network or a personal computer. The storage device is an optical disc recorder, an optical disc drive, a card reader or a hard drive. The output device is a television, a television cable, an optical disc recorder, a display, a hard drive, a card reader, a personal computer, a cable network or a wireless network.

In one embodiment of the foregoing network television video recorder, the function of the image interface unit also includes converting analog image data into digital image data and converting digital image data into analog image data.

In one embodiment of the foregoing network television video recorder, the function of the image processor also includes converting analog image data into digital image data and converting digital image data into analog image data.

The network type television video recorder in the present invention is able to support multiple types of input devices (that is, image sources), storage devices and output devices. Hence, the video recorder can record image from a variety of sources, storing the image in different types of medium and playback the image through a variety of devices. Furthermore, remote operation through a network is also possible. Moreover, the foregoing video recorder is an embedded system using a special chip rather than a personal computer structure so that the production cost is low. In addition, the foregoing input devices, storage devices and output devices can be externally connected instead of built-in. Therefore, an addition casing and necessary peripheral equipment may be incorporated to the video recorder to produce a functionally superior television. Alternatively, the video recorder may be designed as a light and compact independent electronic device so that it is easier to install and carry.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing the architecture of a network type television video recorder according to one embodiment of the present invention.

FIG. 2 is a schematic diagram of a television including a network type television video recorder according to another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

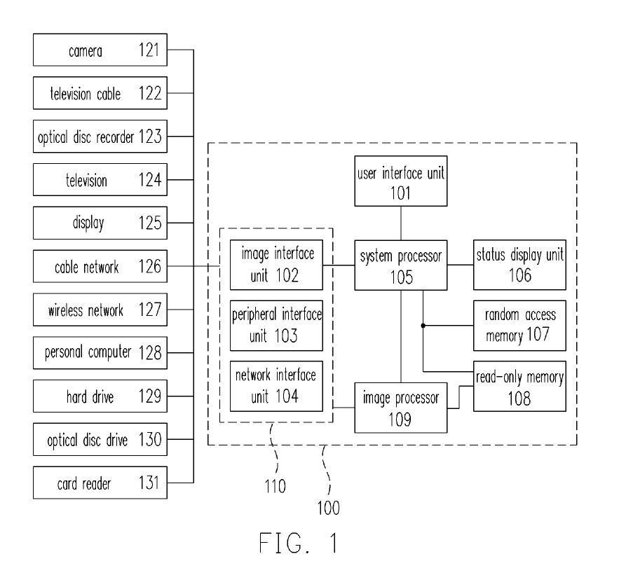

FIG. 1 is a block diagram showing various components of a network type television video recorder 100 according to one embodiment of the present invention. The network type television video recorder 100 includes a user interface unit 101, an interface unit 110, a system processor 105, a status display unit 106, a random access memory (RAM) 107, a read-only memory (ROM) 108 and an image processor 109. The interface unit 110 further comprises an image interface unit 102, a peripheral interface unit 103 and a network interface unit 104.

In brief, the user interface unit 101 is responsible for receiving a local instruction from a user and the network interface unit 104 is responsible for receiving a remote instruction through a network and then transferring the remote instruction to the system processor 105. In the remote operation of the present embodiment, a computer connected to the other end of a network receives a user's instruction. The user may use a computer browser, for example, an Internet Explore browser, to link up with the network type television video recorder 100. Through an operating interface window created after establishing a link between the browser and the video recorder, remote instructions are delivered to the video recorder. However, the scope of the present invention does not limit a user at the remote of a network to effect a remote operation through a browser.

In the present embodiment, the user interface unit 101 is a control panel having at least a keypad for inputting user's local instructions. According to the local instruction or the remote instruction, the system processor 105 executes a recording setting function, a recording function, a management function for managing image data in a storage device (subsequently described) or an image playback function provided by the network type television video recorder 100. Similarly, according to the local instruction or the remote instruction, the image processor 109 compresses image data (generally when recording or storing image data), decompresses image data (generally when playing back the image data) or converts image data format.

The random access memory 107 is a storage device for temporarily holding the data for the system processor to execute the local instructions or the remote instructions. The read-only memory 108 is a storage device for holding the program codes needed to execute the local instructions or the remote instructions. The image interface unit 102, the peripheral interface unit 103 and the network interface unit 104 are coupled to the system processor 105 and the image processor 109. In image recording or playback, image data is read from an input device (subsequently described) or a storage device through one of the three interface units, namely, the image interface unit 102, the peripheral interface unit 103 and the network interface unit 104. Then, the image data is output to the storage device or the output device (subsequently described).

The status display unit 106 is responsible for showing the states of the network type television video recorder 100, for example, the state of the power source or the state of the image playback. In the present embodiment, the foregoing states are displayed using light-emitting diodes (LED).

The foregoing image interface unit 102 has at least one group of image interface connectors so that the image interface unit 102 can transmit image data through one of the image interface connectors. Similarly, the peripheral interface unit 103 has at least one group of peripheral interface connectors so that the peripheral interface unit can transmit image data through one of the peripheral interface connectors. The network interface unit 104 similarly has at least one group of network interface connectors so that the network interface unit 104 can transmit image data through one of the network interface connectors. Because the image interface unit 102, the peripheral interface unit 103 and the network interface unit 104 all have at least one group of connectors, different types of external input devices, storage devices and output devices can be connected simultaneously.

In addition, if the image interface unit 102, the peripheral interface unit 103 and the network interface unit 104 are simultaneously connected to a number of different external input devices, storage devices and output devices, all three interface units or two of the three interface units may operate simultaneously when recording or playing back images. For example, image data are read through the image interface unit 102 or the peripheral interface unit 103 and then the image data are output through the network interface unit 104. Alternatively, image data are read in through both the image interface unit 102 and the peripheral interface unit 103 and then the image data are output through the network interface unit 104.

The peripheral interface connectors of the peripheral interface unit 103 may include Universal Serial Bus (USB) interface connectors for connecting with a personal computer 128 and a card reader 131. However, the peripheral interface unit 103 is not limited to the aforementioned output interface and the personal computer 128 and the card reader 131 is not limited to using only the USB interface in the present invention.

In the present embodiment, the so-called input devices are actually devices capable of providing image data, in other words, an image source. The storage device is a device capable of holding transient image data for subsequent playback. The output devices refer to any device capable of receiving image data from the network type television video recorder 100.

As shown in FIG. 1, the input devices include a cameral 121, a television cable 122, an optical disc recorder 123, a cable network 126, a wireless network 127, a personal computer 128, a hard drive 129, an optical disc drive 130 and a card reader 131. The storage devices include an optical disc recorder 123, a hard drive 129, an optical disc drive 130 and a card reader 131. The output device include a television cable 122, an optical disc recorder 123, a television 124 (for example, the network type television video recorder 100 is fabricated as an independent electronic apparatus), a display 125 (for example, the network type television video recorder 100 is fabricated as part of a television), a cable network 126, a wireless network 127, a personal computer 128, a hard drive 129, an optical disc drive 130 and a card reader 131.

In the embodiment shown in FIG. 1, if the network type television video recorder 100 transmits image data through the image interface unit 102, the input device can be a camera 121, a television cable 122 or an optical disc recorder 123, the storage device can be an optical disc recorder 123 and the output device can be a television 124, a television cable 122, an optical disc recorder 123 or a display 125. If the network type television video recorder 100 transmits image data through the peripheral interface unit 102, the input device can be a hard drive 129, an optical disc drive 130 or a card reader 131, the storage device can be a hard drive 129, an optical disc drive 130 or a card reader 132 and the output device can be a hard drive 129, an optical disc drive 130 or a card reader 131. If the network type television video recorder 100 transmits image data through the network interface unit 104, the input device can be cable network 126, a wireless network 127 or a personal computer 128, the storage device can be a hard drive 129 and the output device can be a personal computer 128, a cable network 126 or a wireless network 127.

According to the embodiment shown in FIG. 1, the network type television video recorder 100 may write image data into a memory card through the card reader 131 or read image data from the memory card through the card reader 131. Similarly, the network type television video recorder 100 may write image data into an optical disc through the optical disc recorder 123 or read image data from the optical disc through the optical disc recorder 123. The types of optical discs used by the optical disc drive 130 and the optical disc recorder 123 include video compact disc (CVD) and digital versatile disc (DVD).

The network type television video recorder 100 may record program from a television program channel transmitted by a television cable 122 or record image captured by a camera 121. In addition, a user at the remote of a network may link up with the network type television video recorder 100 through a computer browser so that the user may deliver remote instructions to the video recorder 100 via the browser. For example, a user at the remote may watch live program from a television program channel or image captured by a camera 121. According to the foregoing remote operating mode, the user at the remote of the network may also watch image data recorded and stored in a hard drive 129 or watch image data extracted from an optical disc by an optical disc drive 130 or an optical disc recorder 123.

The user may use a personal computer 128 to watch images or perform addition processing such as producing printouts. In addition, the type of display 125 used in the present invention is not limited. For example, the display 125 can be a conventional cathode ray tube (CRT), a liquid crystal display (LCD) or a plasma display (PDP).

The recording setting function of the network type television video recorder 100 includes setting a recording speed, setting the quality of recorded picture and presetting the recording time. The recording function of the network type television video recorder 100 includes reading image data from an input device and storing the recorded image data in a storage device. The network type television video recorder 100 uses a digital method to process the image. If the network type television video recorder 100 is connected to an analog input device or output device, a setup for performing a digital-to-analog (D/A) or analogue-to-digital (A/D) conversion is required. In the present embodiment, the image interface unit 102 or the image processor 109 is responsible for performing the foregoing D/A or A/D conversion.

The image data processed by the network type television video recorder 100 can be dynamic image data or static image data. The static image data is a stationary picture that can be extracted from a dynamic image. The image processor 109 may use an MPEG4 format to compress the dynamic image data. The compression format of the MPEG4 may be a CIF format or a QCIF format. Here, MPEG is the short form for motion picture expert group, CIF is the short form for common intermediate format or common interchange format and QCIF is the short form for quarter CIF. In addition, the dynamic image data will be stored in a storage device in AVI format and the static image data will be stored in a storage device in JPEG format. Here, JPEG is the short form for joint picture expert group.

Finally, the playback function of the network type television video recorder 100 is to read image data from an input device or a storage device and output the image data to an output device. The foregoing image playback function includes playing back images selectively according to the recording time, the movie or section of the movie. Furthermore, the image playback may be carried out fast forward, slow motion, frame-by-frame or in a stationary frame manner. Moreover, the image playback can be forward or backward.

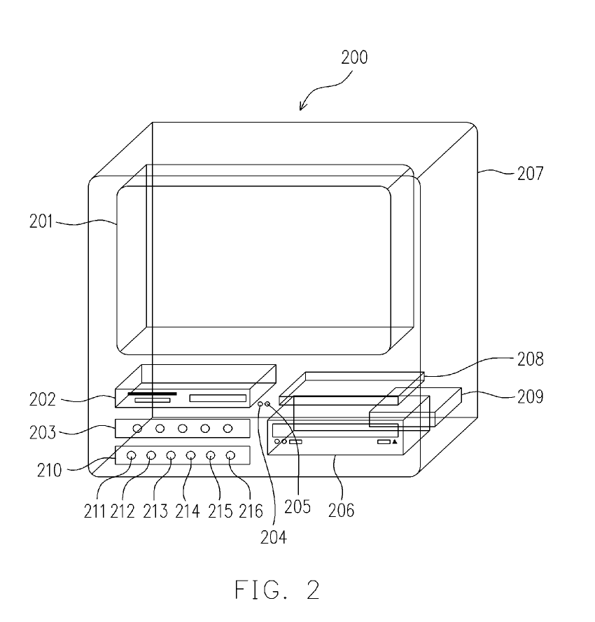

FIG. 2 is a line sketch of a television having a network type television video recorder according to another embodiment of the present invention. As shown in FIG. 2, the core of the television 200 is the network type television video recorder 208 of the present invention. The television 200 mainly includes an outer casing 207, a liquid crystal display 201, a card reader 202, a user interface unit 203, a playback status indicator light 204, a power status indicator light 205, an optical disc recorder 206, a hard drive 209, an interface panel 210 and a network type television video recorder 208.

The card reader 202 has a plurality of sockets for supporting different types of memory cards. The user interface unit 203 includes a control panel with plurality of keys. The playback status indicator light 204 and the power status indicator light 205 are light-emitting diodes belonging to the status display unit of the network type television video recorder 208.

The interface panel 210 includes image interface connectors 211 and 212, peripheral interface connectors 213 and 214, and network interface connectors 215 and 216. The interface connectors on the interface panel 210 are an extension of the interface connectors in the network type television video recorder 208 so that the network type television video recorder 208 can connect with various input devices, output devices and storage devices through these interface connectors. The image interface connectors 211 and 212 may be different types of AV terminals. The peripheral interface connectors 213 and 214 may be plug-and-play USB interface connectors or RJ45 interface connectors. The network interface connectors 215 and 216 may be RJ45 interface connectors or RJ11 interface connectors. However, the interface connectors listed in the foregoing description should by no means limit the scope of the present invention. The user may select the best types of interface connectors on demand.

In summary, the network type television video recorder of the present invention is able to support different types of input devices (image sources), storage devices and output devices concurrently. Therefore, images from different sources can be recorded and the images can be stored in different types of medium. The images can be subsequently playback via different types of devices. Moreover, the network type television video recorder also permits a remote operation through a network. In addition, the foregoing video recorder does not have to be a personal computer. To reduce the production cost, the video recorder can be implemented using a special chip housing an embedded system. Furthermore, the input devices, the storage devices and the output devices can be selectively connected external devices rather than built-in devices. Therefore, a casing and all the required peripheral equipment can be added on the network type television video recorder of the present invention to produce a functionally superior television. However, the video recorder can also be designed as a light and compact independent electronic device for easy installation and portability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A network type television video recorder, comprising:
a user interface unit for receiving a local instruction from a user;
a system processor for executing one of the following functions according to the local instruction or a remote instruction received through a network: a recording setting function, a recording function, a management function for managing image data inside a storage device and an image playback function;
an image processor for executing one of the following operations according to the local instruction or the remote instruction: compressing the image data, decompressing the image data and converting the format of the image data;
a random access memory for temporarily holding the data for the system processor to execute the local instruction or the remote instruction;
a read-only memory for storing program codes needed to execute the local instruction or the remote instruction; and
an interface unit coupled to the system processor and the image processor for reading the image data from an input device or the storage device and outputting the image data to the storage device or an output device,
wherein the interface unit also receives the remote instruction through a network and transmits the remote instruction to the system processor.

2. The network type television video recorder of claim 1, further comprising:
a status display unit for displaying various states of the network type television video recorder, wherein the status display unit comprises at least a light-emitting diode, and the states of the network type television video recorder comprises at least a power state and an image playback state.

3. The network type television video recorder of claim 1, wherein the user interface unit comprises a control panel having at least a keypad.

4. The network type television video recorder of claim 1, wherein the image data is either dynamic image data or static image data.

5. The network type television video recorder of claim 4, wherein the image processor uses MPEG4 format to compress the image data if the image data is dynamic image data.

6. The network type television video recorder of claim 4, wherein the image data is stored in the storage device in AVI format if the image data is dynamic image data;
and the image data is stored in the storage device in JPEG format if the image data is static image data.

7. The network type television video recorder of claim 1, wherein the recording setting function comprises at least one of the following setting operations: setting the recording speed, setting the picture quality of the recording and presetting the recording time.

8. The network type television video recorder of claim 1, wherein the recording function comprises reading the image data from the input device and recording and storing the image data inside the storage device.

9. The network type television video recorder of claim 1, wherein the image playback function comprises reading the image data from the input device or the storage device and outputting the image data to the output device.

10. The network type television video recorder of claim 1, wherein the image playback function comprises playing back images forward, backward, fast forward, in slow speed, frame-by-frame or in a stationary frame manner, the image playback function also comprises selecting images for playback according to recording time, movie title or section title.

11. The network television video recorder of claim 1, wherein the input device is a camera, a television cable, an optical disc recorder, a hard drive, a card reader, an optical disc drive, a cable network a wireless network or a personal computer, the storage device is an optical disc recorder, an optical disc drive, a card reader or a hard drive, and the output device is a television, a television cable, an optical disc recorder, a display, a hard drive, an optical disc drive, a card reader, a personal computer, a cable network or a wireless network.

12. The network type television video recorder of claim 11, wherein the interface unit comprises an image interface unit, a peripheral interface unit and a network interface unit; and, in addition:
if the network type television video recorder transmits image data through the image interface unit, then the input device is a camera, a television cable or an optical disc recorder, the storage device is an optical disc recorder, and the output device is a television, a television cable, an optical disc recorder or a display;
if the network type television video recorder transmits image data through the peripheral interface unit, then the input device is a hard drive, an optical disc drive or a card reader, the storage device is a hard drive, an optical disc drive or a card reader, and the output device is a hard drive, an optical disc drive or a card reader; and
if the network type television video recorder transmits image data through the network interface unit, then the input device is a cable network, a wireless network or a personal computer, the storage device is a hard drive, and the output device is a personal computer, a cable network or a wireless network.

13. The network type television video recorder of claim 12, wherein:
the image interface unit has at least one group of image interface connectors for transmitting image data through one of the image interface connectors;
the peripheral interface unit has at least one group of peripheral interface connectors for transmitting image data through one of the peripheral interface connectors; and
the network interface unit has at least one group of network interface connectors for transmitting image data through one of the network interface connectors.

14. The network type television video recorder of claim 12, wherein the function of the image interface unit further comprises converting analog image data into digital image data and converting digital image data back to analog image data.

15. The network type television video recorder of claim 11, wherein, if the storage device is an optical disc recorder, the network type television video recorder writes the image data to an optical disc through the storage device and reads the image data from the optical disc through the storage device.

16. The network type television video recorder of claim 11, wherein, if the storage device is a card reader, the network type television video recorder writes the image data to a memory card through the storage device and reads the image data from the memory card through the storage device.

17. The network type television video recorder of claim 1, wherein the function of the image processor further comprises converting analog image data into digital image data and converting digital image data back to analog image data.
